(19) United States
(12) Patent Application Publication
(10) Pub. No.: US 2015/0205592 A1
(43) Pub. Date: Jul. 23, 2015

(54) SYSTEM AND METHOD FOR MANAGING APPLICATION PROGRAM FOR TERMINAL

(71) Applicant: ELECTRONICS AND TELECOMMUNICATIONS RESEARCH INSTITUTE, Daejeon (KR)

(72) Inventors: Eun Jeong CHOI, Daejeon (KR); Hye won SONG, Daejeon (KR)

(73) Assignee: ELECTRONICS AND TELECOMMUNICATIONS RESEARCH NSTITUTE, Daejeon (KR)

(21) Appl. No.: 14/602,620

(22) Filed: Jan. 22, 2015

(30) Foreign Application Priority Data
Jan. 23, 2014 (KR) 10-2014-0008257

(51) Int. Cl. G06F 9/445

(52) U.S. Cl. CPC G06F 8/61; G06F 8/65

(57) ABSTRACT

Provided are a system and method for managing application programs for terminals. The system for managing application programs for terminals is configured to manage application programs of given terminals through an application synchronization function all at once. It is possible to install, delete, or change the dedicated application programs of the terminals all at once and purchase the application programs through a designated market, independently of whether the terminals have different platforms, to receive and apply installation information.

### CROSS-REFERENCE TO RELATED APPLICATION

This application claims priority to and the benefit of Korean Patent Application No. 10-2014-0008257, filed on Jan. 23, 2014, the disclosure of which is incorporated herein by reference in its entirety.

### BACKGROUND

1. Field of the Invention

The present invention relates to a system and method for managing an application program for a terminal, and more particularly, to a system and method for managing application programs of terminals all at once.

2. Discussion of Related Art

Conventionally, due to issues of management of partner firms and customers when a salesperson is retired, employees responsible for sales in fields of insurances, stocks, and so on are provided with corporate terminals and forced to manage customers using the corporate terminals.

However, according to the conventional technique, whenever a new application program should be installed in corporate terminals that are given to employees or an application program should be updated for maintenance, the employees having the corporate terminals are required to manually install or update the program.

### SUMMARY OF THE INVENTION

The present invention is directed to a system and method for managing application programs for terminals all at once.

According to an aspect of the present invention, there is provided a system for managing an application program for a terminal, including: a manager terminal configured to transmit information associated with an organization-dedicated application program; and a management server configured to request that a user terminal install an organization-dedicated application program transmitted from the manager terminal and request that the user terminal apply change information of an organization-dedicated application program transmitted from the manager terminal to the installed organization-dedicated application program.

The information associated with the organization-dedicated application program may include at least one of the organization-dedicated application program and a storage instruction for the organization-dedicated application program, an update version of the organization-dedicated application program and a storage instruction for the update version of the organization-dedicated application program, a new organization-dedicated application program different from the organization-dedicated application program and a storage instruction for the new organization-dedicated application program different from the organization-dedicated application program, and a deletion instruction for the organization-dedicated application program.

The system may further include a push server configured to push at least one of an installation message for the organization-dedicated application program, an installation message for the update version of the organization-dedicated application program, an installation message for the new organization-dedicated application program different from the organization-dedicated application program, and a deletion message for the organization-dedicated application program to the user terminal according to a request from the management server.

The management server may store the organization-dedicated application program in a database according to the storage instruction for the organization-dedicated application program and, when the user terminal is registered, may request that the push server push the installation message for the organization-dedicated application program to the registered user terminal

When the management server stores the update version of the organization-dedicated application program in the database according to the storage instruction for the update version of the organization-dedicated application program, the management server may request that the push server push the installation message for the update version of the organization-dedicated application program to the registered user terminal, and when the management server stores the new organization-dedicated application program different from the organization-dedicated application program in the database according to the storage instruction for the new organization-dedicated application program different from the organization-dedicated application program, the management server may request that the push server push the installation message for the new organization-dedicated application program different from the organization-dedicated application program to the registered user terminal.

When the management server deletes the organization-dedicated application program from the database according to the deletion instruction for the organization-dedicated application program, the management server may request that the push server push the deletion message for the organization-dedicated application program to the user terminal.

When the management server is requested, by the user terminal that has installed the organization-dedicated application program, to check change information of the organization-dedicated application program, the management server may check the change information of the organization-dedicated application program and request that the user terminal apply the checked change information of the organization-dedicated application program.

According to another aspect of the present invention, there is provided a system for managing application programs for terminals, including: a management server configured to transmit an installation message for a stored organization-dedicated application program and transmit an application message for change information of the stored organization-dedicated application program; and a plurality of user terminals configured to download the organization-dedicated application program from the management server and install the downloaded organization-dedicated application program according to the installation message received from the management server and configured to download the change information of the organization-dedicated application program from the management server and apply the downloaded change information to the installed organization-dedicated application program according to the application message received from the management server.

Each of the user terminals may access the management server, acquire a user account, install a management client program, and then perform registration with the management server using the installed management client program, and may download the organization-dedicated application program from the management server using the installed management client program and install the downloaded organization-dedicated application program when an installation message for the organization-dedicated application program is received from the management server.

Each of the user terminals may perform at least one of update of the organization-dedicated application program, installation of a new organization-dedicated application program different from the organization-dedicated application program, and deletion of the organization-dedicated application program using the management client program installed according to the application message for the change information of the organization-dedicated application program received from the management server.

According to still another aspect of the present invention, there is provided a method of managing an application program for a terminal in a system for managing an application program for a terminal including a manager terminal and a management server, including: transmitting, by the manager terminal, information associated with an organization-related application program; requesting, by the management server, that a user terminal install the organization-dedicated application program transmitted from the manager terminal; and requesting, by the management server, that the user terminal apply change information of the organization-dedicated application program transmitted from the manager terminal to the installed organization-dedicated application program.

The information associated with the organization-dedicated application program may include at least one of the organization-dedicated application program and a storage instruction for the organization-dedicated application program, an update version of the organization-dedicated application program and a storage instruction for the update version of the organization-dedicated application program, a new organization-dedicated application program different from the organization-dedicated application program and a storage instruction for the new organization-dedicated application program different from the organization-dedicated application program, and a deletion instruction for the organization-dedicated application program.

The method may further include pushing, by a push server included in the system for managing an application program for a terminal, at least one of an installation message for the organization-dedicated application program, an installation message for the update version of the organization-dedicated application program, an installation message for the new organization-dedicated application program different from the organization-dedicated application program, and a deletion message for the organization-dedicated application program to the user terminal according to a request from the management server.

The requesting that the user terminal install the organization-dedicated application program may include storing the organization-dedicated application program in a database according to the storage instruction for the organization-dedicated application program and, when the user terminal is registered, requesting that the push server push the installation message for the organization-dedicated application program to the registered user terminal

The requesting that the user terminal apply the change information to the installed organization-dedicated application program may include: when the update version of the organization-dedicated application program is stored in the database according to the storage instruction for the update version of the organization-dedicated application program, requesting that the push server push the installation message for the update version of the organization-dedicated application program to the registered user terminal; and when the new organization-dedicated application program different from the organization-dedicated application program is stored in the database according to the storage instruction for the new organization-dedicated application program different from the organization-dedicated application program, requesting that the push server push the installation message for the new organization-dedicated application program different from the organization-dedicated application program to the registered user terminal.

The requesting that the user terminal apply the change information to the installed organization-dedicated application program may further include, when the organization-dedicated application program is deleted from the database according to the deletion instruction for the organization-dedicated application program, requesting that the push server push the deletion message for the organization-dedicated application program to the user terminal.

The method may further include: when the management server is requested by the user terminal that has installed the organization-dedicated application program to check change information of the organization-dedicated application program, checking the change information of the organization-dedicated application program; and requesting that the user terminal apply the checked change information of the organization-dedicated application program.

According to still yet another aspect of the present invention, there is provided a method of managing application programs for terminals in a system for managing application programs for terminals including a management server and a plurality of user terminals, including: transmitting, by the management server, an installation message for a stored organization-dedicated application program; downloading, by each of the plurality of user terminals, the organization-dedicated application program from the management server and installing the downloaded organization-dedicated application program according to the installation message received from the management server; transmitting, by the management server, an application message for change information of the stored organization-dedicated application program; and downloading, by each of the plurality of user terminals, the change information of the organization-dedicated application program from the management server and applying the downloaded change information to the installed organization-dedicated application program according to the application message received from the management server.

The downloading and installing of the organization-dedicated application program may include: accessing the management server, acquiring a user account, and then installing a management client program; performing registration with the management server using the installed management client program; and downloading the organization-dedicated application program from the management server using the installed management client program and installing the downloaded organization-dedicated application program when an installation message for the organization-dedicated application program is received from the management server.

The downloading and applying of the change information to the installed organization-dedicated application program may include at least one of updating the organization-dedicated application program, installing a new organization-dedicated application program different from the organization-dedicated application program, and deleting the organization-dedicated application program using the management client program installed according to the application message for the change information of the organization-dedicated application program received from the management server.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a block diagram showing a system for managing an application program for a terminal according to an embodiment of the present invention;

FIG. 2 is a flowchart showing an operating method for a manager terminal of FIG. 1;

FIG. 3 is a flowchart showing an operating method for a management server of FIG. 1; and

FIG. 4 is a flowchart showing an operating method for a plurality of user terminals of FIG. 1.

### DETAILED DESCRIPTION OF EXEMPLARY EMBODIMENTS

Advantages and features of the present invention, and implementation methods thereof will be clarified through the following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

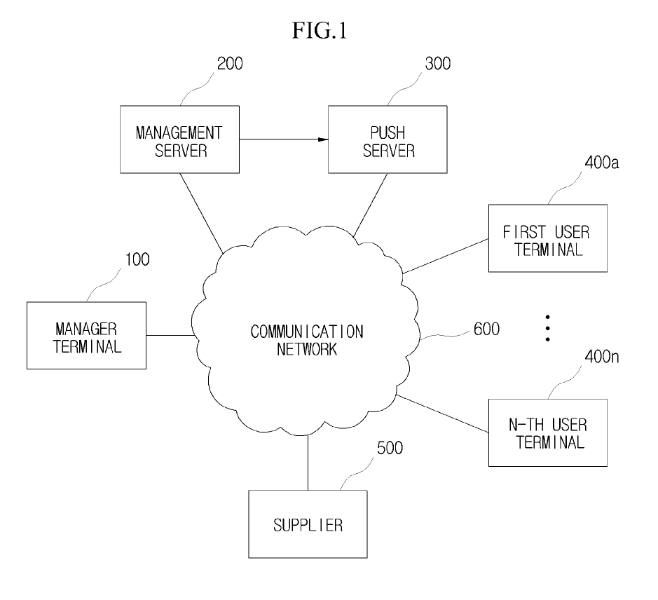

A system for managing an application program for a terminal according to an embodiment of the present invention will be described below with reference to FIG. 1. FIG. 1 is a block diagram showing the system for managing an application program for a terminal according to an embodiment of the present invention.

As shown in FIG. 1, the system for managing an application program for a terminal according to an embodiment of the present invention includes a manager terminal 100, a management server 200, a push server 300, a plurality of user terminals 400a to 400n, and a supplier 500.

The manager terminal 100 may be a terminal that is given to a manager who is responsible for a task of managing employees in specific companies in the fields of insurances and stocks, schools, community groups, or the like (hereinafter collectively referred to as an organization).

The manager terminal 100 transmits an organization-dedicated application program and a management command therefor, which are supplied from the supplier 500 through a communication network 600, to the management server 200.

Here, the communication network 600 is a wireless communication network and supports mobile communication such as WiFi, 3rd Generation (3G), or Long Term Evolution (LTE).

The management server 200 stores an organization-dedicated application program transmitted from the manager terminal 100 in a database according to a management instruction for the organization-dedicated application program transmitted from the manager terminal 100.

The management server 200 requests that the push server 300 push a push message that instructs a plurality of registered user terminals 400a to 400n to download and install the organization-dedicated application program stored in the database.

The push server 300 pushes the push message, which requests installation of the organization-dedicated application program, etc., to the plurality of user terminals 400a to 400n through the communication network 600 according to a request from the management server 200.

The plurality of user terminals 400a to 400n may be terminals that are given to employees who are responsible for actual works in the organizations.

The plurality of user terminals 400a to 400n access the management server 200 through the communication network 600 and perform registration with the accessed management server 200.

When the push message that requests installation of the organization-dedicated application program is received from the push server 300, the plurality of user terminals 400a to 400n that perform registration with the management server 200 may download the organization-dedicated application program from the management server 200 and automatically install the downloaded organization-dedicated application program.

An operation of each element of the system for managing an application program for a terminal according to an embodiment of the present invention will be described in detail below.

First, through the management server 200, the manager terminal 100 manages the organization-dedicated application program or the like that is supplied from the supplier 500 through the communication network 600.

Here, the supplier 500 may supply the organization-dedicated application program or even a general application program anyone may download and install.

For example, the supplier 500 may supply an organization-dedicated application program that is developed by a request from the organization to the manager terminal 100 through the communication network 600. Alternatively, the supplier 500 may supply an update version of the organization-dedicated application program, which fixes a fault of the organization-dedicated application program or enhances its performance when the organization-dedicated application program has the fault, to the manager terminal 100 through the communication network 600. The supplier 500 may supply a new organization-dedicated application program different from the organization-dedicated application program that is newly developed by the request from the organization to the manager terminal 100 through the communication network 600. In addition, the supplier 500 may supply a general application program anyone may download and install through an open market.

The manager terminal 100 receives the organization-dedicated application program, the update version of the organization-dedicated application program, or the new organization-dedicated application program different from the organization-dedicated application program from the supplier 500 through the communication network 600.

Accordingly, the manager terminal 100 transmits the organization-dedicated application program, the update version of the organization-dedicated application program, or the new organization-dedicated application program different from the organization-dedicated application program that is received from the supplier 500 and storage instructions therefor to the management server 200 through the communication network 600.

In addition, when the organization-dedicated application program is a program that is not currently in use, the manager terminal 100 may transmit a deletion instruction for the organization-dedicated application program to the management server 200 through the communication network 600 in terms of managing a storage capacity of the management server 200.

The management server 200 stores or deletes the organization-dedicated application program transmitted from the manager terminal 100 in or from the database according to a management instruction of the manager terminal 100. In addition, the management server 200 requests that the push server 300 push a storage or deletion message for the organization-dedicated application program to the plurality of user terminals 400a to 400n.

For example, the management server 200 stores the organization-dedicated application program, the update version of the organization-dedicated application program, or the new organization-dedicated application program different from the organization-dedicated application program in the database according to a storage instruction that is transmitted from the manager terminal 100 through the communication network 600. In addition, the management server 200 deletes the organization-dedicated application program or the like from the database according to a deletion instruction that is transmitted from the manager terminal 100 through the communication network 600.

When the management server 200 stores the organization-dedicated application program in the database, the management server 200 requests that the push server 300 push an organization-dedicated application program installation message to the plurality of registered user terminals 400a to 400n.

When the management server 200 stores the update version of the organization-dedicated application program or the new organization-dedicated application program different from the organization-dedicated application program in the database, the management server 200 requests that the push server 300 push an installation message for the update version of the organization-dedicated application program or an installation message for the new organization-dedicated application program different from the organization-dedicated application program to the plurality of user terminals 400a to 400n.

When the management server 200 deletes the organization-dedicated application program or the like from the database, the management server 200 requests that the push server 300 push a deletion message for the organization-dedicated application program to the plurality of user terminals 400a to 400n.

The push server 300 pushes a message that is requested by the management server 200 through the communication network 600 to the plurality of user terminals 400a to 400n.

For example, when the push server 300 is requested by the management server 200 to push an installation message for the organization-dedicated application program, the push server 300 pushes the installation message for the organization-dedicated application program to the plurality of user terminals 400a to 400n through the communication network 600.

When the push server 300 is requested by the management server 200 to push an installation message for the update version of the organization-dedicated application program or an installation message for the new organization-dedicated application program different from the organization-dedicated application program, the push server 300 pushes the installation message for the update version of the organization-dedicated application program or the installation message for the new organization-dedicated application program different from the organization-dedicated application program to the plurality of user terminals 400a to 400n through the communication network 600.

In addition, when the push server 300 is requested by the management server 200 to push a deletion message for the organization-dedicated application program, the push server 300 pushes the deletion message for the organization-dedicated application program to the plurality of user terminals 400a to 400n through the communication network 600.

The plurality of user terminals 400a to 400n download the organization-dedicated application program from the management server 200 according to the message pushed by the push server 300 and automatically install the downloaded organization-dedicated application program.

For example, first, the plurality of user terminals 400a to 400n access the management server 200 through the communication network 600. The plurality of user terminals 400a to 400n acquire user accounts from the accessed management server 200 and then install a management client program. The plurality of user terminals 400a to 400n perform registration with the management server 200 using the installed management client program.

When the plurality of user terminals 400a to 400n that perform registration with the management server 200 receive the installation message for the organization-dedicated application program from the push server 300, the plurality of user terminals 400a to 400n download the organization-dedicated application program from the management server 200 using the installed management client program and automatically install the downloaded organization-dedicated application program.

When the plurality of user terminals 400a to 400n receive the installation message for the update version of the organization-dedicated application program or the installation message for the new organization-dedicated application program different from the organization-dedicated application program from the push server 300, the plurality of user terminals 400a to 400n download the update version of the organization-dedicated application program or the new organization-dedicated application program different from the organization-dedicated application program from the management server 200 using the installed management client program and automatically install the update version or the new organization-dedicated application program.

When the plurality of user terminals 400a to 400n receive the deletion message for the organization-dedicated application program from the push server 300, the plurality of user terminals 400a to 400n automatically delete the installed organization-dedicated application program using the installed management client program.

Here, the management server 200 and the push server 300 are separately configured. However, the present invention is not limited thereto, and the push server 300 may be included in the management server 200. In addition, here, the management server 200 is configured such that the plurality of user terminals 400a to 400n that perform registration with the management server 200 automatically install, update, or delete change information of the organization-dedicated application program (registration of the new application program, registration of the update version of the application program, deletion of the application program, and so on). However, the present invention is not limited thereto, and when the management server 200 is requested by the plurality of user terminals 400a to 400n to check the change information of the organization-dedicated application program, the management server 200 may be configured to deliver the change information to the plurality of user terminals 400a to 400n to automatically install, update, or delete the delivered change information.

As described above, according to an embodiment of the present invention, it is possible to install, delete, or change the dedicated application programs of the terminals all at once and purchase the application programs through a designated market, independently of whether the terminals have different platforms, to receive and apply installation information.

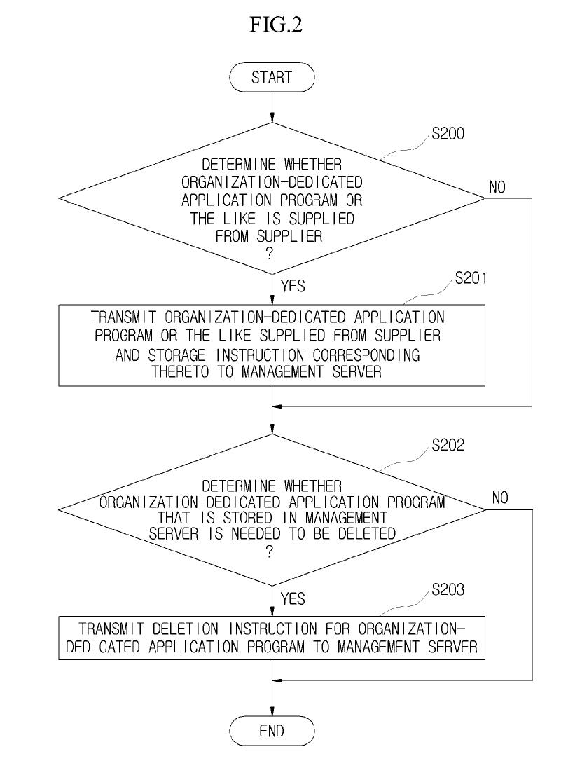

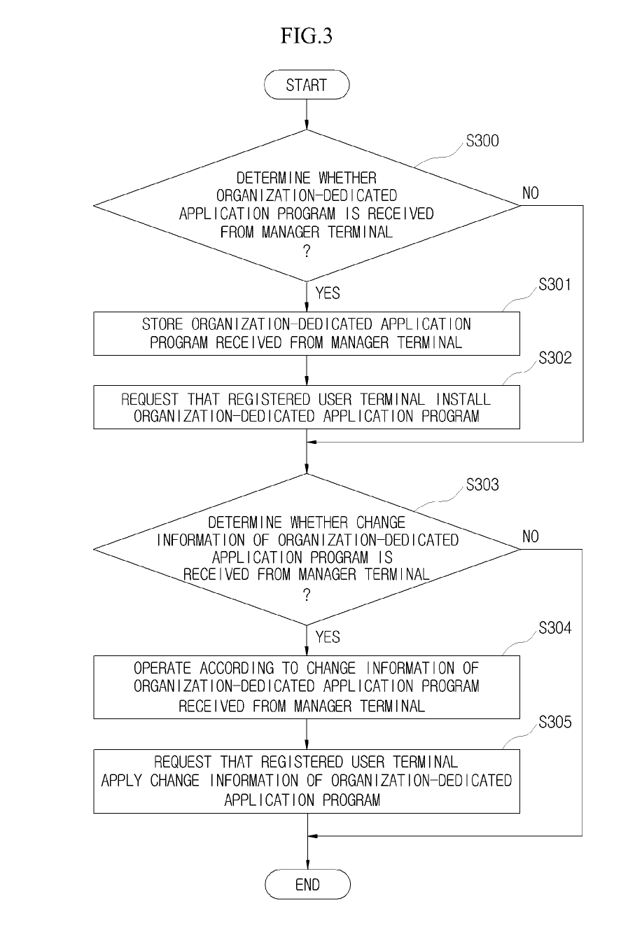

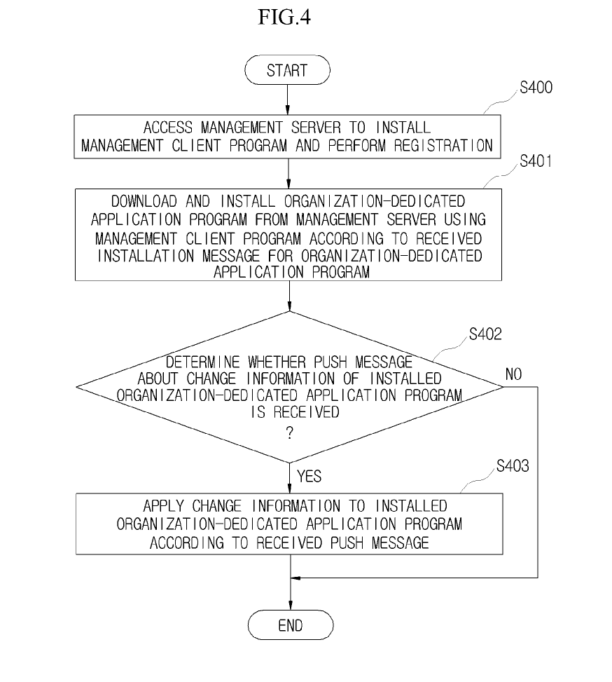

A method of managing an application program for a terminal according to an embodiment of the present invention will be described below with reference to FIGS. 2 to 4. FIG. 2 is a flowchart showing an operating method for a manager terminal of FIG. 1, FIG. 3 is a flowchart showing an operating method for a management server of FIG. 1, and FIG. 4 is a flowchart showing an operating method for a user terminal of FIG. 1.

As shown in FIG. 2, a manager terminal checks whether an organization-dedicated application program or the like is supplied from a supplier through a communication network (S200).

Here, the supplier may supply the organization-dedicated application program or even a general application program anyone may download and install.

For example, the supplier may supply an organization-dedicated application program that is developed by a request from the organization to the manager terminal through the communication network. In addition, the supplier may supply an update version of the organization-dedicated application program, which fixes a fault of the organization-dedicated application program or enhances its performance when the organization-dedicated application program has the fault, to the manager terminal through the communication network. The supplier may supply a new organization-dedicated application program different from the organization-dedicated application program that is newly developed by a request from the organization to the manager terminal through the communication network. In addition, the supplier may supply a general application program anyone may download and install through an open market.

When a result of the check in S200 is that the organization-dedicated application program, the update version of the organization-dedicated application program, or the new organization-dedicated application program different from the organization-dedicated application program is supplied from the supplier through the communication network, the manager terminal transmits the organization-dedicated application program, the update version of the organization-dedicated application program, or the new organization-dedicated application program different from the organization-dedicated application program and a storage instruction therefor to a management server (S201).

In addition, the manager terminal determines whether the organization-dedicated application program, etc. that is stored in the management server is needed to be deleted (S202).

For example, the manager terminal may determine that the deletion is needed because the organization-dedicated application program is not currently in use in terms of managing storage capacity of the management server.

When a result of the determination in S202 is that the organization-dedicated application program, etc. that is stored in the management server is needed to be deleted, the manager terminal transmits a deletion instruction for the organization-dedicated application program, etc. to the management server through the communication network (S203).

As shown in FIG. 3, the management server stores or deletes the organization-dedicated application program transmitted from the manager terminal in or from a database according to a management instruction of the manager terminal.

For example, the management server determines whether the organization-dedicated application program and the storage instruction therefor are received from the manager terminal (S300).

When a result of the determination is that the organization-dedicated application program and the storage instruction therefor are received from the manager terminal, the management server stores the organization-dedicated application program in the database according to the storage command that is received from the manager terminal (S301).

Next, the management server pushes a push message that requests installation of the organization-dedicated application program to a registered user terminal using a push server (S302).

The management server determines whether change information of the organization-dedicated application program and a storage instruction therefor are received from the manager terminal (S303).

For example, the management server determines whether an update version of the organization-dedicated application program or a new organization-dedicated application program different from the organization-dedicated application program is received from the manager terminal through the communication network. In addition, the management server determines whether a deletion instruction for the organization-dedicated application program is received from the manager terminal through the communication network.

When a result of the determination is that the change information of the organization-dedicated application program is received from the manager terminal, the management server operates according to the change information of the organization-dedicated application program received from the manager terminal (S304).

For example, when the update version of the organization-dedicated application program or the new organization-dedicated application program different from the organization-dedicated application program is received from the manager terminal, the management server stores the received update version of the organization-dedicated application program or new organization-dedicated application program different from the organization-dedicated application program in the database. In addition, when the management server receives the deletion instruction for the organization-dedicated application program from the manager terminal, the management server deletes the organization-dedicated application program from the database.

Next, the management server requests that the registered user terminal apply the change information of the organization-dedicated application program (S305).

For example, the management server pushes a push message that requests installation of the update version of the organization-dedicated application program or the new organization-dedicated application program different from the organization-dedicated application program to the registered user terminal using the push server. In addition, the management server pushes a push message that requests deletion of the organization-dedicated application program to the registered user terminal using the push server.

As shown in FIG. 4, a plurality of user terminals download the organization-dedicated application program from the management server according to the push message that is received from the push server and automatically install the downloaded organization-dedicated application program.

For example, first, the plurality of user terminals access the management server through the communication network. The plurality of user terminals acquire user accounts from the accessed management server and then install a management client program. The plurality of user terminals perform registration with the management server using the installed management client program (S400).

When the plurality of user terminals that perform registration with the management server receive an installation message for the organization-dedicated application program from the push server, the plurality of user terminals download the organization-dedicated application program from the management server using the installed management client program and automatically install the downloaded organization-dedicated application program (S401).

Next, the plurality of user terminals determine whether a push message about change information of the installed organization-dedicated application program is received (S402).

For example, the plurality of user terminals determine whether an installation message for the update version of the organization-dedicated application program, an installation message for the new organization-dedicated application program different from the organization-dedicated application program, or a deletion message for the organization-dedicated application program is received from the push server.

When a result of the determination is that the push message about the change information of the installed organization-dedicated application program is received from the push server, the plurality of user terminals download the change information of the organization-dedicated application program from the management server according to the received push message and apply the downloaded change information to the installed organization-dedicated application program (S403).

For example, when the plurality of user terminals receive the installation message for the update version of the organization-dedicated application program or the installation message for the new organization-dedicated application program different from the organization-dedicated application program from the push server, the plurality of user terminals download the update version of the organization-dedicated application program or the new organization-dedicated application program different from the organization-dedicated application program from the management server using the installed management client program and automatically install the downloaded update version or new organization-dedicated application program.

In addition, when the plurality of user terminals receive the deletion message for the organization-dedicated application program from the push server, the plurality of user terminals automatically delete the installed organization-dedicated application program using the installed management client program.

According to an embodiment of the present invention, it is possible to install/delete/change application programs of respective terminals all at once.

It is also possible to easily download the application programs through a designated market, independently of whether the terminals have different platforms, and apply the downloaded installation programs.

It should be understood that although the present invention has been described above in detail with reference to the accompanying drawings and exemplary embodiments, this is illustrative only and various change may be made without departing from the spirit or scope of the invention. Thus, the scope of the present invention is to be determined by the following claims and their equivalents, and shall not be restricted or limited by the foregoing detailed description.

What is claimed is:

1. A system for managing an application program for a terminal, the system comprising:
a manager terminal configured to transmit information associated with an organization-dedicated application program; and
a management server configured to request that a user terminal install an organization-dedicated application program transmitted from the manager terminal and request that the user terminal apply change information of an organization-dedicated application program transmitted from the manager terminal to the installed organization-dedicated application program.

2. The system of claim 1, wherein the information associated with the organization-dedicated application program includes at least one of the organization-dedicated application program and a storage instruction for the organization-dedicated application program, an update version of the organization-dedicated application program and a storage instruction for the update version of the organization-dedicated application program, a new organization-dedicated application program different from the organization-dedicated application program and a storage instruction for the new organization-dedicated application program different from the organization-dedicated application program, and a deletion instruction for the organization-dedicated application program.

3. The system of claim 2, further comprising a push server configured to push at least one of an installation message for the organization-dedicated application program, an installation message for the update version of the organization-dedicated application program, an installation message for the new organization-dedicated application program different from the organization-dedicated application program, and a deletion message for the organization-dedicated application program to the user terminal according to a request from the management server.

4. The system of claim 3, wherein the management server stores the organization-dedicated application program in a database according to the storage instruction for the organization-dedicated application program and, when the user terminal is registered, requests that the push server push the installation message for the organization-dedicated application program to the registered user terminal.

5. The system of claim 4, wherein when the management server stores the update version of the organization-dedicated application program in the database according to the storage instruction for the update version of the organization-dedicated application program, the management server requests that the push server push the installation message for the update version of the organization-dedicated application program to the registered user terminal, and wherein when the management server stores the new organization-dedicated application program different from the organization-dedicated application program in the database according to the storage instruction for the new organization-dedicated application program different from the organization-dedicated application program, the management server requests that the push server push the installation message for the new organization-dedicated application program different from the organization-dedicated application program to the registered user terminal.

6. The system of claim 5, wherein when the management server deletes the organization-dedicated application program from the database according to the deletion instruction for the organization-dedicated application program, the management server requests that the push server push the deletion message for the organization-dedicated application program to the user terminal.

7. The system of claim 1, wherein when the management server is requested, by the user terminal that has installed the organization-dedicated application program, to check change information of the organization-dedicated application program, the management server checks the change information of the organization-dedicated application program and requests that the user terminal apply the checked change information of the organization-dedicated application program.

8. A system for managing application programs for terminals, the system comprising:
a management server configured to transmit an installation message for a stored organization-dedicated application program and transmit an application message for change information of the stored organization-dedicated application program; and
a plurality of user terminals configured to download the organization-dedicated application program from the management server and install the downloaded organization-dedicated application program according to the installation message received from the management server and configured to download the change information of the organization-dedicated application program from the management server and apply the downloaded change information to the installed organization-dedicated application program according to the application message received from the management server.

9. The system of claim 8, wherein each of the user terminals accesses the management server, acquires a user account, installs a management client program, and then performs registration with the management server using the installed management client program, and downloads the organization-dedicated application program from the management server using the installed management client program and installs the downloaded organization-dedicated application program when an installation message for the organization-dedicated application program is received from the management server.

10. The system of claim 9, wherein each of the user terminals performs at least one of update of the organization-dedicated application program, installation of a new organization-dedicated application program different from the organization-dedicated application program, and deletion of the organization-dedicated application program using the management client program installed according to the application message for the change information of the organization-dedicated application program received from the management server.

11. A method of managing an application program for a terminal in a system for managing an application program for a terminal including a manager terminal and a management server, the method comprising:
transmitting, by the manager terminal, information associated with an organization-related application program;
requesting, by the management server, that a user terminal install the organization-dedicated application program transmitted from the manager terminal; and
requesting, by the management server, that the user terminal apply change information of the organization-dedicated application program transmitted from the manager terminal to the installed organization-dedicated application program.

12. The method of claim 11, wherein the information associated with the organization-dedicated application program includes at least one of the organization-dedicated application program and a storage instruction for the organization-dedicated application program, an update version of the organization-dedicated application program and a storage instruction for the update version of the organization-dedicated application program, a new organization-dedicated application program different from the organization-dedicated application program and a storage instruction for the new organization-dedicated application program different from the organization-dedicated application program, and a deletion instruction for the organization-dedicated application program.

13. The method of claim 12, further comprising pushing, by a push server included in the system for managing an application program for a terminal, at least one of an installation message for the organization-dedicated application program, an installation message for the update version of the organization-dedicated application program, an installation message for the new organization-dedicated application program different from the organization-dedicated application program, and a deletion message for the organization-dedicated application program to the user terminal according to a request from the management server.

14. The method of claim 13, wherein the requesting that the user terminal install the organization-dedicated application program comprises:
storing the organization-dedicated application program in a database according to the storage instruction for the organization-dedicated application program and;
when the user terminal is registered, requesting that the push server push the installation message for the organization-dedicated application program to the registered user terminal.

15. The method of claim 14, wherein the requesting that the user terminal apply the change information to the installed organization-dedicated application program comprises:
when the update version of the organization-dedicated application program is stored in the database according to the storage instruction for the update version of the organization-dedicated application program, requesting that the push server push the installation message for the update version of the organization-dedicated application program to the registered user terminal; and
when the new organization-dedicated application program different from the organization-dedicated application program is stored in the database according to the storage instruction for the new organization-dedicated application program different from the organization-dedicated application program, requesting that the push server push the installation message for the new organization-dedicated application program different from the organization-dedicated application program to the registered user terminal.

16. The method of claim 15, wherein the requesting that the user terminal apply the change information to the installed organization-dedicated application program further comprises, when the organization-dedicated application program is deleted from the database according to the deletion instruction for the organization-dedicated application program, requesting that the push server push the deletion message for the organization-dedicated application program to the user terminal

17. The method of claim 11, further comprising:
when the management server is requested, by the user terminal that has installed the organization-dedicated application program, to check change information of the organization-dedicated application program, checking the change information of the organization-dedicated application program; and
requesting that the user terminal apply the checked change information of the organization-dedicated application program.

18. A method of managing application programs for terminals in a system for managing application programs for terminals including a management server and a plurality of user terminals, the method comprising:
transmitting, by the management server, an installation message for a stored organization-dedicated application program;
downloading, by each of the plurality of user terminals, the organization-dedicated application program from the management server and installing the downloaded organization-dedicated application program according to the installation message received from the management server;
transmitting, by the management server, an application message for change information of the stored organization-dedicated application program; and
downloading, by each of the plurality of user terminals, the change information of the organization-dedicated application program from the management server and applying the downloaded change information to the installed organization-dedicated application program according to the application message received from the management server.

19. The method of claim 18, wherein the downloading and installing of the organization-dedicated application program comprises:
accessing the management server, acquiring a user account, and then installing a management client program;
performing registration with the management server using the installed management client program; and
downloading the organization-dedicated application program from the management server using the installed management client program and installing the downloaded organization-dedicated application program when an installation message for the organization-dedicated application program is received from the management server.

20. The method of claim 19, wherein the downloading and applying of the change information to the installed organization-dedicated application program comprises at least one of updating the organization-dedicated application program, installing a new organization-dedicated application program different from the organization-dedicated application program, and deleting the organization-dedicated application program using the management client program installed according to the application message for the change information of the organization-dedicated application program received from the management server.
